(19) United States
(12) Patent Application Publication
(10) Pub. No.: US 2025/0075979 A1
(43) Pub. Date: Mar. 6, 2025

(54) FIXING APPARATUS FOR FURNACE WIRE OF FURNACE BODY HEATER

(71) Applicant: Shanghai Huali Microelectronics Corporation, Shanghai (CN)

(72) Inventor: Sheng Tang, Shanghai (CN)

(73) Assignee: Shanghai Huali Microelectronics Corporation, Shanghai (CN)

(21) Appl. No.: 18/631,193

(22) Filed: Apr. 10, 2024

(30) Foreign Application Priority Data
Aug. 30, 2023 (CN) 202311109303.2

(51) Int. Cl. F27D 11/02; H05B 3/64; H05B 3/66

(52) U.S. Cl. CPC F27D 11/02; H05B 3/64; H05B 3/66

(57) ABSTRACT

The present application provides a fixing apparatus for a furnace wire of a furnace body heater, which is formed by assembling a plurality of fixing units. A structure of each of the fixing units includes: a front end structure and a tail end structure connected together. The front end structure is provided with a first recess and a second recess. The tail end structure is provided with a third recess and a fourth protrusion block. Two adjacent ones of the fixing units form a first splice structure, in the first splice structure, the fourth protrusion block of the fixing unit at the top is snap fitted in the third recess of the fixing unit at the bottom to achieve fixation. An opening of a first recess of the fixing unit at the bottom and an opening of a second recess of the fixing unit at the top are butt-jointed together.

### CROSS-REFERENCE TO RELATED APPLICATIONS

This application claims the priority to Chinese patent application No. 202311109303.2, filed on Aug. 30, 2023, the disclosure of which is incorporated herein by reference in its entirety.

### TECHNICAL FIELD

The present application relates to a semiconductor integrated circuit manufacturing device, in particular to a fixing apparatus for a furnace wire of a furnace body heater.

### BACKGROUND

In a furnace, a furnace body heater is an apparatus for providing a process temperature, with a heating temperature of 400-1200 C°, which is a hollow cylinder having a closed top. A wafer boat loaded with wafers is lifted into the furnace body heater by means of a lifter to implement a process.

A furnace wire is a heating carrier of the furnace body heater, which is arranged as surrounding the interior of the entire furnace body heater and fixed on the furnace body by means of insulators and penetration rods.

After the use of the furnace body heater for a period of time, for example, after more than 3 years of use, a resistance wire of the furnace body, i.e., the furnace wire, may be bent and deformed. A failure mode is as follows: the furnace wire drops under its own weight, making a gap between the furnace wire and the insulator smaller, causing the insulator to tilt, increasing the friction with the penetration rod, causing the insulator to be unable to absorb the deformation of the penetration rod generated by thermal expansion and contraction, and causing the insulator to get loose.

Design defects of the existing insulator are as follows:

The penetration rod is used for fixing, and the deformation of the penetration rod causes a deformation protrusion of the furnace wire.

A front end of the insulator is an arc surface, a gap is always present, and thus the furnace wire cannot be fixed effectively.

FIG. 1 is a schematic diagram of a sectional structure of a furnace body of an existing furnace. The furnace body 101 is of a hollow cylindrical structure with a closed top and an open bottom.

A wafer boat 102 is loaded with a plurality of wafers 103 and lifted to a corresponding position in the furnace body 101 by means of a lifter to implement a furnace process.

A heater, i.e., a furnace body heater, is disposed on an inner side surface of the furnace body 101.

FIG. 2 is a schematic diagram of a top view surface structure of the existing furnace body heater. An insulation layer 105 is disposed on an inner wall 104 of the furnace body 101. The heater is disposed inside the insulation layer 105 and formed by a furnace wire 109, i.e., a resistance wire, surrounding the interior of the furnace body 101.

The furnace wire 109 is required to be fixed using insulators 106 and penetration rods 108. FIG. 2 shows a plurality of the insulators 106, and the insulators 106 at positions of the same height in the furnace body 101 are used for passage and fixation of a circle of the furnace wire 109. In the top view of FIG. 2, the insulator 106 corresponding to each angular position corresponds to a column of the stacked insulators 106.

Each of the insulators 106 has a penetration rod hole 107, and all the penetration rod hole 107 of all the insulators 106 in the same column are aligned for the penetration rod 108 to pass through to achieve fixing.

A hole for passage and fixation of the furnace wire 109 is then formed between two of the insulators 106.

FIG. 3A is a schematic diagram of a stack structure of two adjacent insulators in an existing furnace body heater. The insulator at the top is marked with a mark 106a individually, and a furnace wire passing through and being fixed at the top of the insulator 106a is marked with a mark 109a individually. As can be seen from a front end area shown in a box 110, contact surfaces of the two insulators 106 and 106a are both arc surfaces, and a gap as shown in a circle 111 is present between the two insulators 106 and 106a. As the use time increases, the furnace wire 109a moves along an arrow line 113, and the gap shown by the circle 111 then causes the insulator 106a to rotate along an arrow line 112 and move to a position corresponding to a dashed line 114, and the insulator 106a tilts. Referring to FIG. 3B, which is a schematic diagram of the tilted insulator at the top in FIG. 3A, the tilted insulator is denoted using a mark 106b individually.

FIG. 3C is a stereoscopic diagram corresponding to FIG. 3B. It can be seen that, as the use time of the furnace body heater increases, dropping of the furnace wire 109a and tilting of the insulator 106a occur, then the penetration rod 108 passing through the penetration rod hole 107 deforms, and eventually the furnace wire 109a is unable to be fixed ineffectively, causing a deformation protrusion of the furnace wire 109a. FIG. 4 is a photograph of the existing furnace body heater. In FIG. 4, a mark 206 is used to denote the insulator, a mark 209 is used to denote the furnace wire, and it can be seen that protrusions of the furnace wire are present at many positions on the entire heater, as denoted by the mark 209a.

### BRIEF SUMMARY

According to some embodiments in this application, a fixing apparatus for a furnace wire of a furnace body heater provided by the present application is formed by assembling a plurality of fixing units of the same structure.

A structure of each of the fixing units includes: a front end structure and a tail end structure connected together.

The front end structure is provided with a first recess and a second recess.

The first recess is a recess that is concave downward from a top surface of the front end structure, an opening of the first recess is located on the top surface of the front end structure, and a body of the first recess is located inside the front end structure.

The second recess is a recess that is concave upward from a bottom surface of the front end structure, an opening of the second recess is located on the bottom surface of the front end structure, and a body of the second recess is located inside the front end structure.

The tail end structure is provided with a third recess and a fourth protrusion block.

The third recess is a recess that is concave downward from a top surface of the tail end structure, an opening of the third recess is located on the top surface of the tail end structure, and a body of the third recess is located inside the tail end structure.

The fourth protrusion block is a protrusion block extending downward from a bottom surface of the tail end structure, a top surface of the fourth protrusion block is located on the bottom surface of the tail end structure, and a body of the fourth protrusion block is located below the bottom surface of the tail end structure.

Two adjacent ones of the fixing units form a first splice structure, and in the first splice structure, the fourth protrusion block of the fixing unit at the top is snap fitted in the third recess of the fixing unit at the bottom, achieving fixed splicing between the fixing unit at the top and the fixing unit at the bottom; the opening of the first recess of the fixing unit at the bottom and the opening of the second recess of the fixing unit at the top are butt-jointed together, the body of the first recess and the body of the second recess are spliced to form a first hole, and the first hole is for passage of a furnace wire.

In some cases, on a sectional structure along a direction from the front end structure to the tail end structure, the first recess is arc-shaped, the second recess is arc-shaped, and the first hole is circular in shape.

In some cases, on the sectional structure along the direction from the front end structure to the tail end structure, the first recess and the second recess are both semi-circular in shape.

In some cases, on the sectional structure along the direction from the front end structure to the tail end structure, the body of the third recess and the body of the fourth protrusion block are both dovetail-shaped.

In some cases, during the splicing of the two adjacent ones of the fixing units, outside the opening of the first recess and the third recess of the fixing unit at the bottom, a bottom surface of the fixing unit at the top is in planar contact with a top surface of the fixing unit at the bottom.

In some cases, a plurality of pairs of the third recess and the fourth protrusion block that cooperate with each other are disposed in the tail end structure.

In some cases, a furnace body is of a hollow cylindrical structure, and the furnace body has a closed top and an open bottom.

In some cases, the heater is formed by laying the furnace wire along an inner side surface of the furnace body in circles from the bottom to the top.

In some cases, along a direction from the bottom to the top of the furnace body, all the fixing units of the same column are sequentially spliced together in a manner of the first splice structure, so as to form a splice column.

In some cases, along a circumference of the furnace body, the fixing apparatus includes a plurality of the splice columns.

In some cases, materials of the front end structure and the tail end structure of each of the fixing units are the same insulating material.

In the present application, the third recess and the fourth protrusion block are disposed in the tail end structure of the fixing unit. The third recess and the fourth protrusion block of the adjacent fixing units are snap fitted with each other so that the two adjacent ones of the fixing units can be spliced to form the tight first splice structure. Since the first splice structure is a tight structure, the two adjacent ones of the fixing units are less liable to slide and deform, making a structure of the first hole formed by butt-jointing of the first recess and the second recess in the front end structure stable, so that the furnace wire can be fixed in the first hole stably, thereby making the furnace wire less liable to be deformed and damaged. Therefore, the present application can effectively fix the furnace wire so that the furnace wire is less liable to be deformed and damaged, thereby increasing a service life of the furnace body heater and improving a product yield.

### BRIEF DESCRIPTION OF THE DRAWINGS

The present application is further described in detail below in connection with the drawings and specific implementations:

FIG. 1 is a schematic diagram of a sectional structure of a furnace body of an existing furnace;

FIG. 2 is a schematic diagram of a top view structure of an existing furnace body heater;

FIG. 3A is a schematic diagram of a stack structure of two adjacent insulators in the existing furnace body heater;

FIG. 3B is a schematic diagram of a tilted insulator at the top in FIG. 3A;

FIG. 3C is a stereoscopic diagram corresponding to FIG. 3B;

FIG. 4 is a photograph of the existing furnace body heater;

FIG. 5A is a side view of a fixing unit for a furnace wire of a furnace body heater according to embodiments of the present application;

FIG. 5B is a side view of a first splice structure formed by splicing two adjacent fixing units for a furnace wire of a furnace body heater according to embodiments of the present application;

FIG. 6 is a stereoscopic diagram corresponding to FIG. 5B; and

FIG. 7 is a photograph of the furnace body heater according to embodiments of the present application.

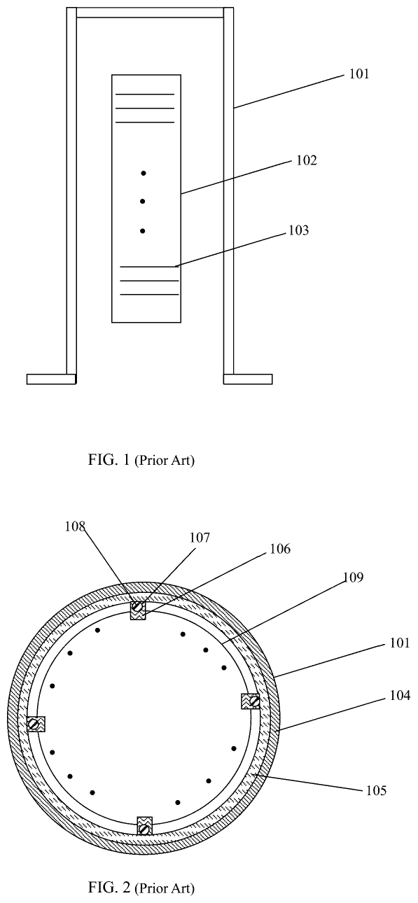

### DETAILED DESCRIPTION OF THE DISCLOSURE

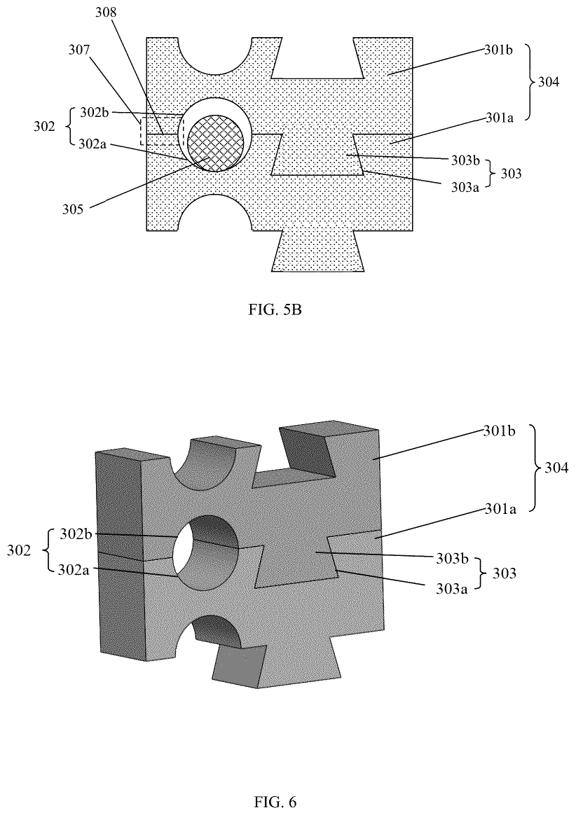

FIG. 5A is a side view of a fixing unit for a furnace wire of a furnace body 101 heater according to embodiments of the present application. FIG. 5B is a side view of a first splice structure formed by splicing two adjacent fixing units for a furnace wire of a furnace body 101 heater according to embodiments of the present application. FIG. 6 is a stereoscopic diagram corresponding to FIG. 5B. A fixing apparatus for a furnace wire of a furnace body 101 heater according to embodiments of the present application is formed by assembling a plurality of fixing units of the same structure.

Referring to FIG. 5A, a structure of each of the fixing units 301 includes: a front end structure and a tail end structure connected together.

In the embodiments of the present application, materials of the front end structure and the tail end structure of each of the fixing units 301 are the same insulating material.

The front end structure is provided with a first recess 302a and a second recess 302b.

The first recess 302a is a recess that is concave downward from a top surface of the front end structure, an opening of the first recess 302a is located on the top surface of the front end structure, and a body of the first recess 302a is located inside the front end structure.

The second recess 302b is a recess that is concave upward from a bottom surface of the front end structure, an opening of the second recess 302b is located on the bottom surface of the front end structure, and a body of the second recess 302b is located inside the front end structure.

The tail end structure is provided with a third recess 303a and a fourth protrusion block 303b.

The third recess 303a is a recess that is concave downward from a top surface of the tail end structure, an opening of the third recess 303a is located on the top surface of the tail end structure, and a body of the third recess 303a is located inside the tail end structure.

The fourth protrusion block 303b is a protrusion block extending downward from a bottom surface of the tail end structure, a top surface of the fourth protrusion block 303b is located on the bottom surface of the tail end structure, and a body of the fourth protrusion block 303b is located below the bottom surface of the tail end structure.

Referring to FIG. 5B and FIG. 6 at the same time, two adjacent ones of the fixing units 301 form a first splice structure, and in the first splice structure, the fourth protrusion block 303b of the fixing unit 301 at the top is snap fitted in the third recess 303a of the fixing unit 301 at the bottom, forming a snap fit structure as shown by a mark 303, and achieving fixed splicing between the fixing unit 301 at the top and the fixing unit 301 at the bottom. The opening of the first recess 302a of the fixing unit 301 at the bottom and the opening of the second recess 302b of the fixing unit 301 at the top are butt-jointed together, the body of the first recess 302a and the body of the second recess 302b are spliced to form a first hole 302, and the first hole 302 is for passage of a furnace wire 305.

In the embodiments of the present application, on a sectional structure along a direction from the front end structure to the tail end structure, the first recess 302a is arc-shaped, the second recess 302b is arc-shaped, and the first hole 302 is circular in shape. In an example, on the sectional structure along the direction from the front end structure to the tail end structure, the first recess 302a and the second recess 302b are both semi-circular in shape.

In the embodiments of the present application, on the sectional structure along the direction from the front end structure to the tail end structure, the body of the third recess 303a and the body of the fourth protrusion block 303b are both dovetail-shaped. In the embodiments of the present application, there is only one pair of the body of the third recess 303a and the body of the fourth protrusion block 303b. In other embodiments, a plurality of pairs of the third recess 303a and the fourth protrusion block 303b that cooperate with each other may be disposed in the tail end structure.

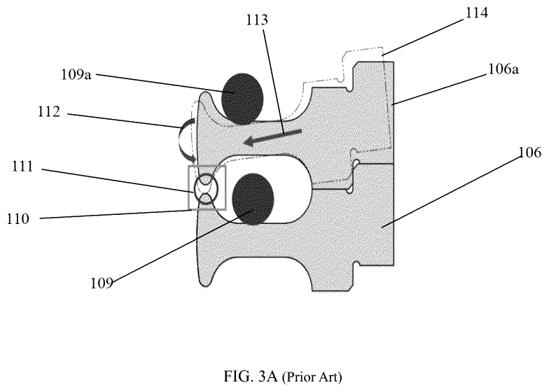

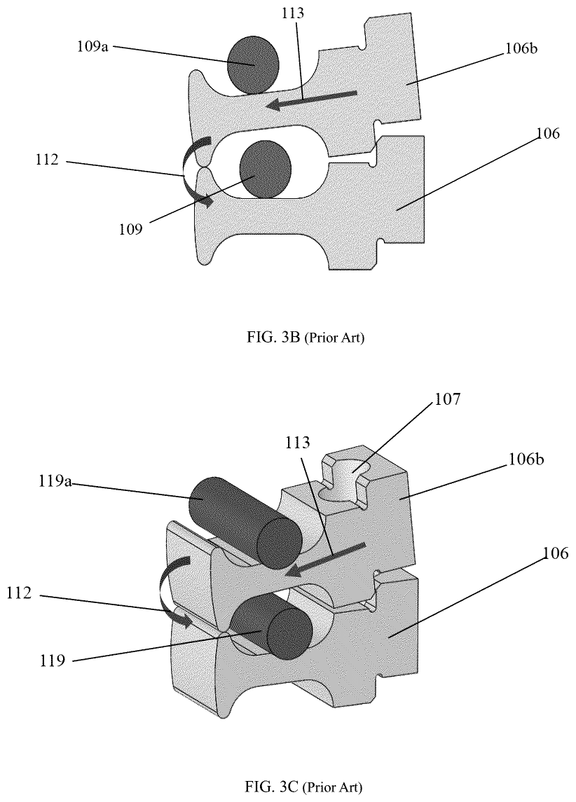

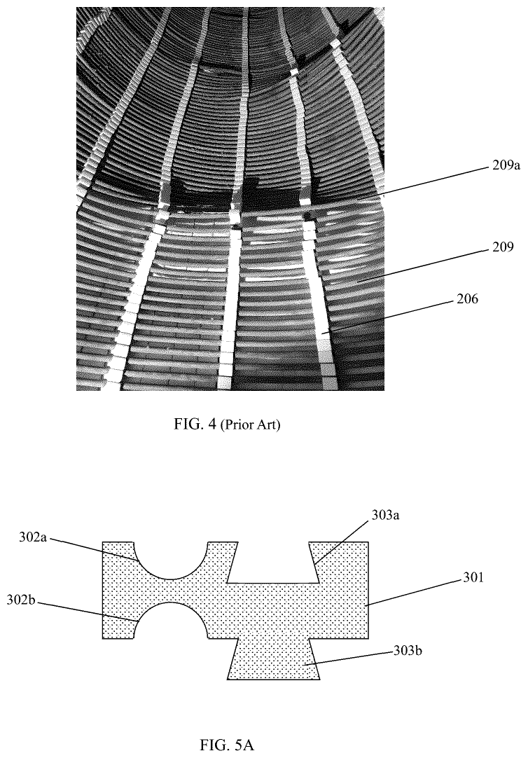

In the embodiments of the present application, during the splicing of the two adjacent ones of the fixing units 301, outside the opening of the first recess 302a and the third recess 303a of the fixing unit 301 at the bottom, a bottom surface of the fixing unit 301 at the top is in planar contact with a top surface of the fixing unit 301 at the bottom. As such, in a front end contact area as shown by a dashed line box 307, a contact surface 308 is in planar contact, without a gap in the existing structure corresponding to FIG. 3A, thereby preventing the fixing unit 301 at the top from tilting.

A structure of the entire furnace body 101 of the present application is as shown in FIG. 1. The furnace body 101 is of a hollow cylindrical structure, and the furnace body 101 has a closed top and an open bottom.

The heater is formed by laying the furnace wire 305 along an inner side surface of the furnace body 101 in circles from the bottom to the top.

Along a direction from the bottom to the top of the furnace body, all the fixing units 301 of the same column are sequentially spliced together in a manner of the first splice structure, so as to form a splice column.

Along a circumference of the furnace body 101, the fixing apparatus includes a plurality of the splice columns.

In the embodiments of the present application, the third recess 303a and the fourth protrusion block 303b are disposed in the tail end structure of the fixing unit 301. The third recess 303a and the fourth protrusion block 303b of the adjacent fixing units 301 are snap fitted with each other so that the two adjacent ones of the fixing units 301 can be spliced to form the tight first splice structure. Since the first splice structure is a tight structure, the two adjacent ones of the fixing units 301 are less liable to slide and deform, making a structure of the first hole 302 formed by butt-jointing of the first recess 302a and the second recess 302b in the front end structure stable, so that the furnace wire 305 can be fixed in the first hole 302 stably, thereby making the furnace wire 305 less liable to be deformed and damaged. Therefore, the present application can effectively fix the furnace wire 305 so that the furnace wire 305 is less liable to be deformed and damaged, thereby increasing a service life of the furnace body 101 heater and improving a product yield.

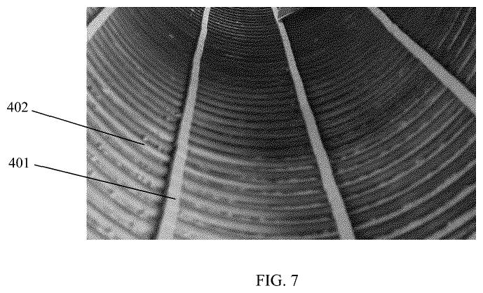

FIG. 7 is a photograph of the furnace body heater according to embodiments of the present application. The splice column formed by the fixing units 301 is denoted by a mark 401 individually, and the furnace wire is denoted by a mark 402 individually. It can be seen that the furnace wire 402 of the embodiments of the present application is well fixed so as to be less liable to deform, eventually increasing the service life and improving the product yield.

The present application is described in detail above through specific embodiments, which, however, do not constitute limitations on the present application. Without departing from the principles of the present application, a person skilled in the art can also make many modifications and improvements, which should also be considered as the scope of protection of the present application.

What is claimed is:

1. A fixing apparatus for a furnace wire of a furnace body heater, which is formed by assembling a plurality of fixing units of a same structure; wherein
a structure of each of the fixing units comprises: a front end structure and a tail end structure connected together;
the front end structure is provided with a first recess and a second recess;
the first recess is a recess that is concave downward from a top surface of the front end structure, an opening of the first recess is located on the top surface of the front end structure, and a body of the first recess is located inside the front end structure;
the second recess is a recess that is concave upward from a bottom surface of the front end structure, an opening of the second recess is located on the bottom surface of the front end structure, and a body of the second recess is located inside the front end structure;
the tail end structure is provided with a third recess and a fourth protrusion block;
the third recess is a recess that is concave downward from a top surface of the tail end structure, an opening of the third recess is located on the top surface of the tail end structure, and a body of the third recess is located inside the tail end structure;
the fourth protrusion block is a protrusion block extending downward from a bottom surface of the tail end structure, a top surface of the fourth protrusion block is located on the bottom surface of the tail end structure, and a body of the fourth protrusion block is located below the bottom surface of the tail end structure;
two adjacent ones of the fixing units form a first splice structure, and in the first splice structure, the fourth protrusion block of the fixing unit at the top is snap fitted in the third recess of the fixing unit at the bottom, achieving fixed splicing between the fixing unit at the top and the fixing unit at the bottom; and the opening of the first recess of the fixing unit at the bottom and the opening of the second recess of the fixing unit at the top are butt-jointed together, the body of the first recess and the body of the second recess are spliced to form a first hole, and the first hole is for passage of the furnace wire.

2. The fixing apparatus for the furnace wire of the furnace body heater according to claim 1, wherein on a sectional structure along a direction from the front end structure to the tail end structure, the first recess is arc-shaped, the second recess is arc-shaped, and the first hole is circular in shape.

3. The fixing apparatus for the furnace wire of the furnace body heater according to claim 2, wherein on the sectional structure along the direction from the front end structure to the tail end structure, the first recess and the second recess are both semi-circular in shape.

4. The fixing apparatus for the furnace wire of the furnace body heater according to claim 2, wherein on the sectional structure along the direction from the front end structure to the tail end structure, the body of the third recess and the body of the fourth protrusion block are both dovetail-shaped.

5. The fixing apparatus for the furnace wire of the furnace body heater according to claim 1, wherein during the splicing of the two adjacent ones of the fixing units, outside the opening of the first recess and the third recess of the fixing unit at the bottom, a bottom surface of the fixing unit at the top is in planar contact with a top surface of the fixing unit at the bottom.

6. The fixing apparatus for the furnace wire of the furnace body heater according to claim 1, wherein a plurality of pairs of the third recess and the fourth protrusion block that cooperate with each other are disposed in the tail end structure.

7. The fixing apparatus for the furnace wire of the furnace body heater according to claim 1, wherein a furnace body is of a hollow cylindrical structure, and the furnace body has a closed top and an open bottom.

8. The fixing apparatus for the furnace wire of the furnace body heater according to claim 7, wherein the heater is formed by laying the furnace wire along an inner side surface of the furnace body in circles from the bottom to the top.

9. The fixing apparatus for the furnace wire of the furnace body heater according to claim 8, wherein along a direction from the bottom to the top of the furnace body, all of the fixing units of a same column are sequentially spliced together in a manner of the first splice structure, so as to form a splice column.

10. The fixing apparatus for the furnace wire of the furnace body heater according to claim 9, wherein along a circumference of the furnace body, the fixing apparatus comprises a plurality of the splice columns.

11. The fixing apparatus for the furnace wire of the furnace body heater according to claim 1, wherein materials of the front end structure and the tail end structure of each of the fixing units are a same insulating material.
